(19) United States
(12) Patent Application Publication
(10) Pub. No.: US 2006/0048590 A1
(43) Pub. Date: Mar. 9, 2006

(54) ADJUSTABLE OPTICAL MACHINERY

(76) Inventors: Fan Chieh Chang, Hsin-Chu City (TW); Hsiu Feng Yeh, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 10/711,022

(22) Filed: Aug. 18, 2004

(51) Int. Cl. H01Q 3/08

(52) U.S. Cl. 74/1 R

(57) ABSTRACT

An adjustable machinery of an optical device includes a first frame for locating the optical device and a second frame for locating the first frame. The first frame has a first alignment hole, a second alignment hole, and a third alignment hole. The second frame has a first adjustment hole, a second adjustment hole, and a third adjustment hole. The first and second frames can relatively shift along a first direction. When locating the first frame on the second frame, the alignment holes and the adjustment holes are partially overlapped, and the relative positions of the first and second frames can be adjusted by changing the relative positions of the alignment holes and the adjustment holes.

### BACKGROUND OF INVENTION

1. Field of the Invention

The invention relates to adjustable machinery, and more particularly, to adjustable machinery that can tune position of an optical device without specific tools.

2. Description of the Prior Art

When assembling optical equipment, center of the optical axis and focusing or imaging position of the optical device must be carefully adjusted, so the installation frames of the optical devices are generally designed as adjustable machinery. The conventional adjustable machinery of the optical device utilizes a pressing screw and a pulling spring to fix the position, and a specific tool is required when tuning position of the installation frame of the optical device.

Please refer to FIG. 1, which is the conventional installation machinery 10 of an optical device 18. The installation machinery 10 includes a first frame 12 and a second frame 14. The optical device 18 is installed on the first frame 12, and the first frame 12 is installed on the second frame 14. The first frame 12 and the second frame 14 can be moved along a predetermined direction, and fixed by a pressing screw 16 and a pulling spring 20. When adjusting position of the optical device 18, the relative positions of the first frame 12 and the second frame 14 can be pulled or relaxed by screwing the pressing screw 16, and the first frame 12 and the second frame 14 can be fastened by the pulling spring 20.

However, the conventional installation machinery has some disadvantages. When using the pressing screw 16 to adjust the relative position, the pressing screw 16 must be specifically designed in accordance with each installation machinery 10, so the pressing screw 16 is complex and expensive. When using the pulling spring 20 to fasten the frames, the installation machinery 10 will also have problems of elastic deformation and reliability. In addition, the specific tool for adjusting position of the install frame will increase the cost and the conventional installation machinery 10 occupies a large space.

### SUMMARY OF INVENTION

It is therefore a primary objective of the claimed invention to provide adjustable machinery that can tune position of an optical device without specific tools and has good precision and reliability to solve the above-mentioned problem.

According to the claimed invention, an adjustable machinery of an optical device is disclosed. The adjustable machinery includes a first frame for locating the optical device and a second frame for locating the first frame. The first frame has a first alignment hole, a second alignment hole, and a third alignment hole. The second frame has a first adjustment hole, a second adjustment hole, and a third adjustment hole. The first and second frames can relatively shift along a first direction. When locating the first frame on the second frame, the alignment holes and the adjustment holes are partially overlapped, and the relative positions of the first and second frames can be adjusted by changing the relative positions of the alignment holes and the adjustment holes.

According to the claimed invention, another adjustable machinery of an optical device is further disclosed. The adjustable machinery includes a first frame for locating the optical device and a second frame for locating the first frame. The first frame has a plurality of alignment holes. The second frame has a plurality of adjustment holes. The first and second frames can relatively shift along a first direction. When locating the first frame on the second frame, the alignment holes and the adjustment holes are partially overlapped, and the relative positions of the first and second frames can be adjusted by changing the relative positions of the alignment holes and the adjustment holes.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a schematic diagram of installation machinery of an optical device according to the prior art.

FIG. 2 is a front view of adjustable machinery of an optical device according to the present invention.

FIG. 3 is a rear view of adjustable machinery of the optical device according to the present invention.

FIGS. 4-6 are schematic diagrams showing the relative positions of alignment holes and adjustment holes according to the present invention.

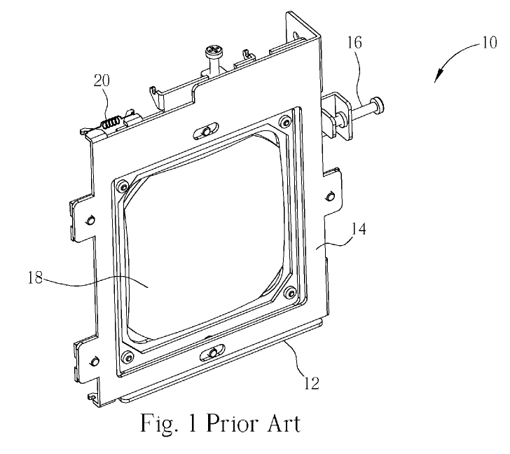

### DETAILED DESCRIPTION

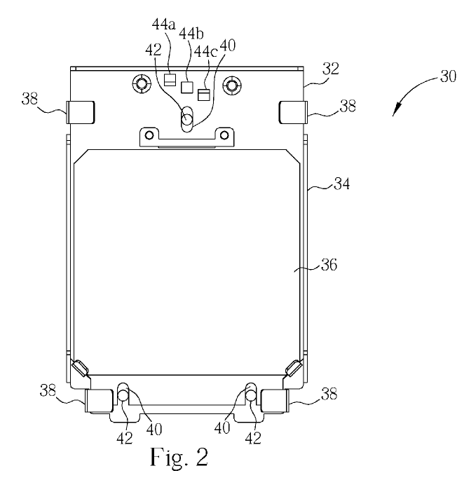

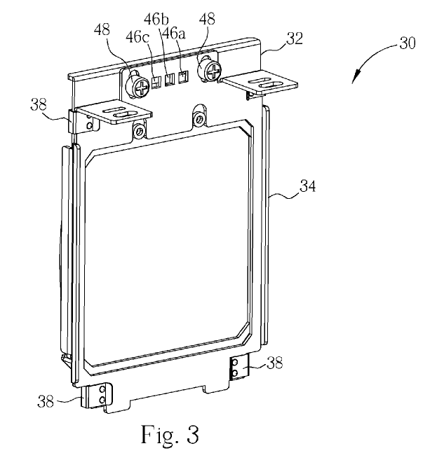

Please refer to FIGS. 2 and 3, which are a front view and a rear view of an adjustable machinery 30 of an optical device according to the present invention. The adjustable machinery 30 includes a first frame 32 and a second frame 34. An optical device 36 is installed on the first frame 32. The optical device 36 can be any kind of optical lens, such as convex lens, concave lens, or plane mirror. A clamp 38 assembles the first frame 32 and the second frame 34. When assembling the first frame 32 and the second frame 34, a trench 40 can be made on the first frame 32, a corresponding prominence 42 can be made on the second frame 34 for limiting relative movement of the first frame 32 to the second frame 34 only along a predetermined direction.

The first frame 32 has three alignment holes 44a, 44b, and 44c. The first alignment hole 44a, the second alignment hole 44b, and the third alignment hole 44c are not arranged in a straight line. The second frame 34 has three adjustment holes 46a, 46b, and 46c. The first adjustment hole 46a, the second adjustment hole 46b, and the third adjustment hole 46c are arranged in a straight line. When the first frame 32 and the second frame 34 are assembled, the alignment holes 44a, 44b, and 44c and the adjustment holes 46a, 46b, and 46c are partially overlapped. The overlapped area can be adjusted by moving the alignment holes 44a, 44b, and 44c relative to the adjustment holes 46a, 46b, and 46c, the relative positions of the first frame 32 to the second frame 34 also changing. Of course, when designing the adjustable machinery 30, the three alignment holes 44a, 44b, 44c can be arranged in a straight line and the three adjustment holes 46a, 46b, 46c not in a straight line. This design also makes these holes partially overlapped.

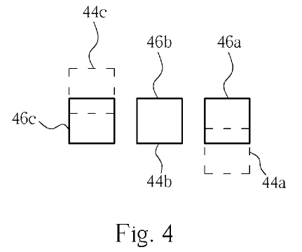

Please refer to FIGS. 4 to 6, which explain the change of the relative positions of the first frame 32 and the second frame 34 when moving the alignment holes 44a, 44b, and 44c and the adjustment holes 46a, 46b, and 46c. When observing the relative positions of the alignment holes 44a, 44b, and 44c and the adjustment holes 46a, 46b, and 46c from the rear side of the adjustable machinery 30 (the direction shown in FIG. 3), the solid line indicates the adjustment holes 46a, 46b, and 46c and the dotted line indicates the alignment holes 44a, 44b, and 44c. In FIG. 4, the alignment hole 44b is fully overlapped with the adjustment hole 46b, and the alignment holes 44a, 44c and the adjustment holes 46a, 46c are partially overlapped. In this situation, the relative position of the first frame 32 and the second frame 34 is at center of the movable range.

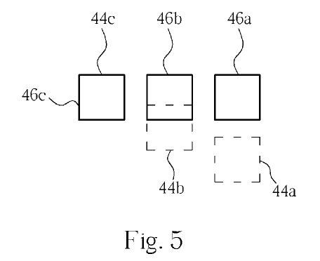

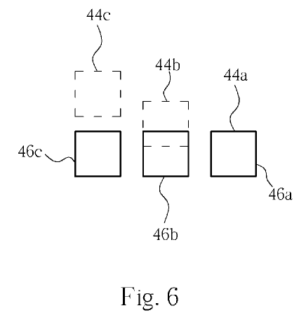

With gradual changing of the sizes of the overlapped areas of the alignment holes 44a, 44b, and 44c and the adjustment holes 46a, 46b, and 46c, the relative positions of the first frame 32 and the second frame 34 can be also adjusted. When the overlapped area of the alignment hole 44c and the adjustment hole 46c becomes larger and the overlapped areas of the alignment holes 44a and 44b and the adjustment holes 46a and 46b becomes smaller, the first frame 32 is relatively moved downward or the second frame 34 is relatively moved upward. When the alignment hole 44c is adjusted to fully overlap the adjustment hole 46c, as shown in FIG. 5, the two frames are at a movable limit in one direction. On the contrary, if positions of the alignment holes 44a, 44b, and 44c and the adjustment holes 46a, 46b, and 46c are changed to make the overlapped area of the alignment hole 44a and the adjustment hole 46a larger, the first frame 32 will be relatively moved upward or the second frame 34 will be relatively moved downward. When the alignment hole 44a is adjusted to fully overlap the adjustment hole 46a, as shown in FIG. 6, these two frames are at a movable limit in the opposite direction.

When changing positions of the alignment holes 44a, 44b, and 44c and the adjustment holes 46a, 46b, and 46c, a proper sized screw driver or any other proper sized tool can be inserted into one of the gaps between the alignment holes 44a, 44b, and 44c and the adjustment holes 46a, 46b, and 46c, and be rotated or pushed. The present invention does not require any specific tool, and any proper sized ready-made tool can be used. The cost of manufacturing specific tools is saved. In addition, shapes of the alignment holes 44a, 44b, and 44c and the adjustment holes 46a, 46b, 46c are not limited to being rectangular, and other shapes, such as ellipses or triangles, can be also used to achieve the present invention.

After adjusting positions of the first frame 32 and the second frame 34, a screw 48 is fastened to prevent the first frame 32 and the second frame 34 from shifting. In addition, the second frame 34 can be further installed onto a third frame (not shown), and the second frame 34 and the third frame can relatively shift along another direction. Extending with this structure, the present invention can be also applied to the multi-axis adjustable machinery. The number of the alignment and adjustment holes is not limited in three, and two or more than three holes are also suitable to the present invention.

In contrast to the prior art, the present invention has advantages of good reliability, easy adjustment, simple design, and low cost, so that the complex structure can be effectively improved.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. An adjustable machinery for tuning position of an optical device, the adjustable machinery comprising:
a first frame for locating the optical device, the first frame having a first alignment hole, a second alignment hole, and a third alignment hole; and
a second frame for locating the first frame, the second frame having a first adjustment hole, a second adjustment hole, and a third adjustment hole, and the first and the second frames can relatively shift along a first direction;
wherein, when locating the first frame onto the second frame, the alignment holes and the adjustment holes are partially overlapped, and relative positions of the first and the second frames can be adjusted by changing relative positions of the alignment holes and the adjustment holes.

2. The adjustable machinery of claim 1 further comprising at least a guide device.

3. The adjustable machinery of claim 2, wherein the guide device includes a trench and a prominence.

4. The adjustable machinery of claim 1 further comprising a screw for fastening the frames.

5. The adjustable machinery of claim 4, wherein after adjusting relative positions of the first and the second frames, the screw is screwed to fasten the first and the second frames.

6. The adjustable machinery of claim 1, wherein a third frame can be further located on the second frame, and the second and the third frames can relatively shift along a second direction.

7. The adjustable machinery of claim 1, wherein the first, the second, and the third alignment holes are rectangles.

8. The adjustable machinery of claim 1, wherein the first, the second, and the third adjustment holes are rectangles.

9. An adjustable machinery for tuning position of an optical device, the adjustable machinery comprising:
a first frame for locating the optical device, the first frame having a plurality of alignment holes; and
a second frame for locating the first frame, the second frame having a plurality of adjustment holes, and the first and the second frames can relatively shift along a first direction;
wherein, when locating the first frame onto the second frame, the alignment holes and the adjustment holes are partially overlapped and can be used to adjust relative positions of the first and the second frames along the first direction.

10. The adjustable machinery of claim 9, wherein relative positions of the first and the second frames are adjusted by changing relative positions of the alignment holes and the adjustment holes.

11. The adjustable machinery of claim 9 further comprising at least a guide device.

12. The adjustable machinery of claim 11, wherein the guide device includes a trench and a prominence.

13. The adjustable machinery of claim 9 further comprising a screw for fastening the frames.

14. The adjustable machinery of claim 13, wherein after adjusting relative positions of the first and the second frames, the screw is screwed to fasten the first and the second frames.

15. The adjustable machinery of claim 9, wherein a third frame can be further located on the second frame, and the second and the third frames can relatively shift along a second direction.
